(19) United States
(12) Patent Application Publication
(10) Pub. No.: US 2020/0282546 A1
(43) Pub. Date: Sep. 10, 2020

(54) ENGINE STAND

(71) Applicant: Gray Manufacturing Company, Inc., St. Joseph, MO (US)

(72) Inventor: Ryan Herzog, St. Joseph, MO (US)

(21) Appl. No.: 16/810,262

(22) Filed: Mar. 5, 2020

Related U.S. Application Data
(60) Provisional application No. 62/813,879, filed on Mar. 5, 2019.

(51) Int. Cl. B25H 1/00; B66C 23/48

(52) U.S. Cl. CPC B25H 1/0007; B66F 9/06; B66C 23/485

(57) ABSTRACT

An adapter assembly for an equipment stand is provided. The adapter assembly comprises an adapter plate and a plurality of support arm assemblies. The adapter plate comprises a plurality of horizontally-extending grooves and a plurality of vertically-extending grooves. Each groove is formed through a thickness of the adapter plate. The plurality of support arm assemblies extend from the adapter plate and are configured to engage with and to support a piece of equipment. The adapter assembly includes a first support arm assembly associated with a first horizontally-extending groove and a second support arm assembly associated with a first vertically-extending groove.

### RELATED APPLICATIONS

This non-provisional patent application claims priority benefit, with regard to all common subject matter, of commonly assigned U.S. provisional patent application Ser. No. 62/813,879, filed Mar. 5, 2019, and entitled “UNIVERSAL ENGINE STAND” (“the '879 application”). The '879 application is hereby incorporated by reference in its entirety into the present non-provisional patent application.

### BACKGROUND

### 1. Field of the Invention

The present disclosure generally relates to engine stands. More particularly, the present disclosure concerns an adapter and an engine stand configured to support a broad range of equipment and a method of securing the equipment to the adapter and/or engine stand.

### 2. Description of the Prior Art

Vehicle engines are generally very large and very heavy, which makes them difficult to maintain and repair. Engine stands are often used to support engines above the ground to provide better access to the engines during time-intensive repairs (e.g., engine overhauls). Different types of engines often have fastening locations at different locations on the engines. Additionally, some engines are more voluminous than others, so their fastening locations may be separated by greater distances. Unfortunately, engine stands are generally configured to only support one specific type of engine. Thus, repair shops are often required to maintain multiple different types of engines stands (or engine stand adapters) to accommodate each of the different types of engines that might be repaired in the shop.

As such, there is a need for an engine stand that can be used for multiple types of engines. Furthermore, there is a need for an engine stand adapter that accommodates the multiple types of engines.

### SUMMARY

Embodiments of the invention solve the above-mentioned problem by providing an engine stand operable to support different types of engines. One embodiment of the invention is directed to an adapter assembly for an equipment stand. The adapter assembly comprises an adapter plate and a plurality of support arm assemblies. The adapter plate includes a plurality of horizontally-extending grooves and a plurality of vertically-extending grooves. Each groove is formed through a thickness of the adapter plate.

The plurality of support arm assemblies extend from the adapter plate and are configured to engage with and to support a piece of equipment. One of the support arm assemblies is associated with a first horizontally-extending groove, and a second support arm assembly is associated with a first vertically-extending groove. The grooves on the adapter plate enable the support arm assemblies to extend from different positions along their associated grooves. This allows the support arm assemblies to be reconfigured to support different types of equipment. For example, the support arm assemblies may extend from different positions along their associated grooves to match fastening locations of different types of engines.

Another embodiment of the invention is an engine stand for supporting an engine above the ground. The engine stand comprises a support frame and an adapter assembly. The adapter assembly comprises an adapter plate and a plurality of support arm assemblies. The adapter plate includes a plurality of horizontally-extending grooves and a plurality of vertically-extending grooves. Each groove is formed through a thickness of said adapter plate. The plurality of support arm assemblies extend from the adapter plate and are configured to engage with and to support the engine above the ground. One of the support arm assemblies is associated with a first horizontally-extending groove, and a second support arm assembly is associated with a first vertically-extending groove.

Another embodiment of the invention is a method of supporting an engine above the ground with an engine stand. The method comprises (a) positioning an adapter assembly of the engine stand adjacent to the engine, wherein the adapter assembly includes an adapter plate having a plurality of horizontally-extending grooves and a plurality of vertically-extending grooves, wherein the adapter assembly additionally includes a plurality of support arm assemblies extending from the adapter plate; (b) actuating a first support arm assembly horizontally through a first horizontally-extending groove of the adapter plate; (c) actuating a second support arm assembly vertically through a first vertically-extending groove of the adapter plate; and (d) securing the first support arm assembly and the second support arm assembly to the engine.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 is a perspective view of an engine stand constructed according to an embodiment of the present invention supporting an engine;

FIG. 2 is a lowered perspective view of the engine stand of FIG. 1;

FIG. 3 is a side perspective view of the engine stand shown in FIG. 1 raising the engine;

FIG. 4 is a perspective view of the engine stand shown in FIG. 1 being aligned with the engine;

FIG. 5 is a perspective view of the engine stand shown in FIG. 1 aligned with fastening locations on the engine;

FIG. 6 is a partial view of a portion of an adapter assembly of the embodiment of the engine stand shown in FIG. 1;

FIG. 7 is an exploded view of the adapter assembly shown in FIG. 6 with support arm assemblies detached;

FIG. 8 is a partial exploded view of support arm assemblies of the adapter assembly shown in FIG. 6; and

FIG. 9 is a flowchart illustrating steps for supporting an engine above the ground with an engine stand according to an embodiment of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF EMBODIMENTS

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. For instance, the drawing figures do not limit the present invention to the specific embodiments disclosed and described herein. Furthermore, directional references (for example, top, bottom, up, and down) are used herein solely for the sake of convenience and should be understood only in relation to each other. For instance, a component might in practice be oriented such that faces referred to as “top” and “bottom” are sideways, angled or inverted relative to the chosen frame of reference.

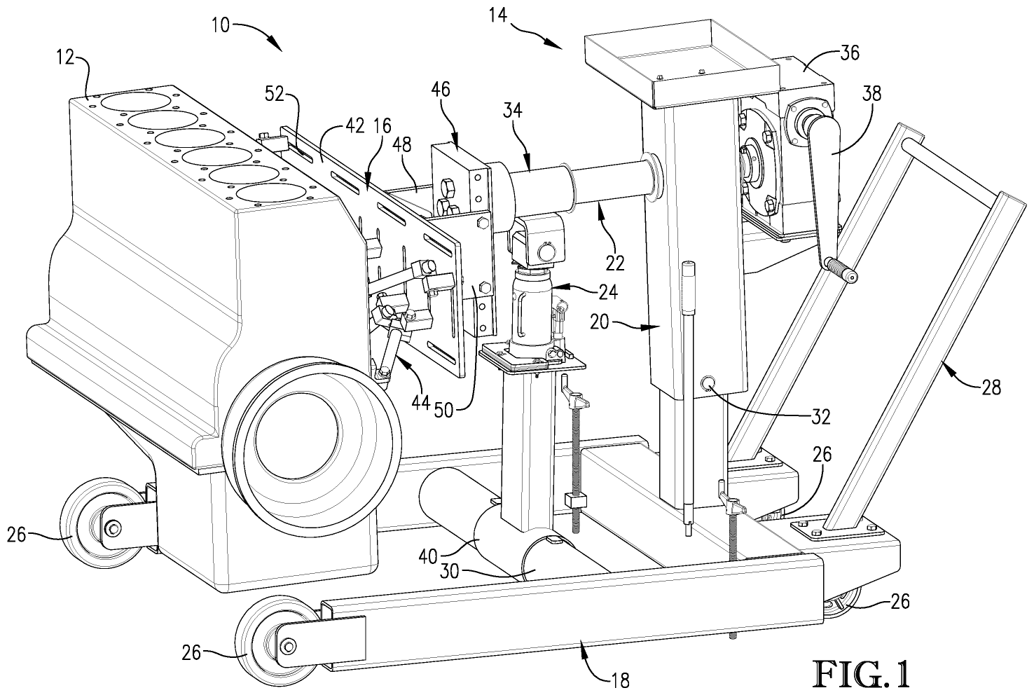

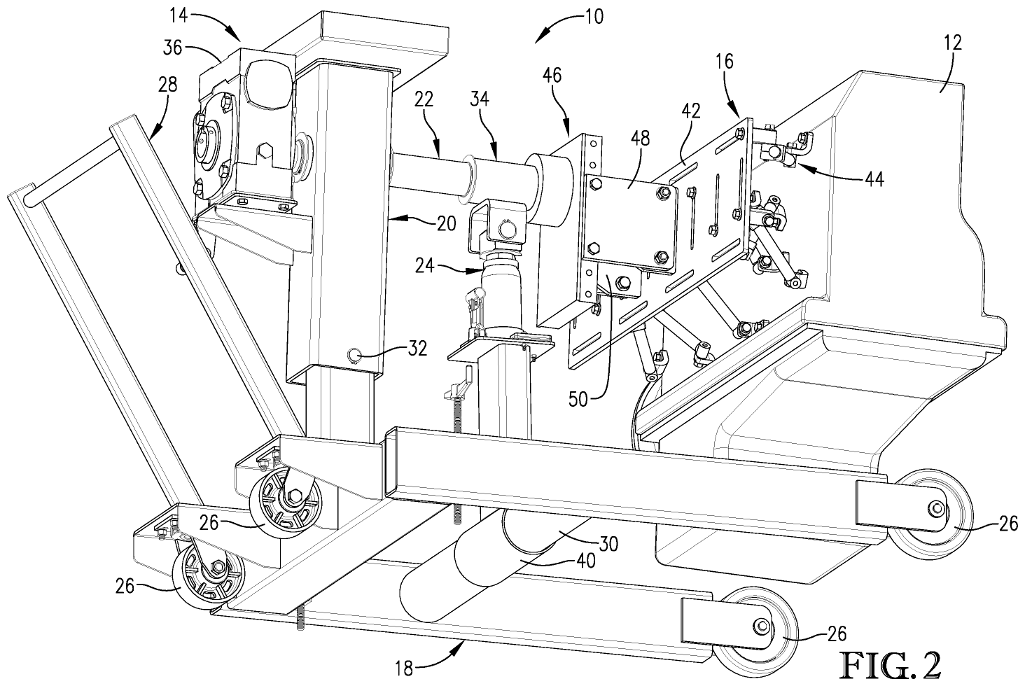

Embodiments of the present invention are directed to an engine stand 10, as illustrated in FIGS. 1 and 2. The engine stand 10 is configured to support a piece of equipment 12, such as an engine, and may comprise a support frame 14 configured to support an adapter assembly 16 above the ground. The piece of equipment 12 may be a ground-vehicle engine (such as a tractor-trailer engine), an aircraft engine, a marine engine, a transmission, an axle carrier, or the like. The engine stand 10 may be configured to support any size of equipment 12, including equipment 12 that weighs up to 6,000 pounds (lbs.) (2,722 kilograms (kg)) or more. For example, the engine stand 10 may be configured to support an engine 12 weighing between 1 and 2,000 lbs. (1 and 907 kg), between 2,001 and 4,000 lbs. (908 and 1,814 kg), and/or between 4,001 and 6,000 lbs. (1,815 and 2,722 kg).

The support frame 14 supports the adapter assembly 16 and the equipment 12 and may comprise a base 18, a support column 20 attached to the base 18, a support shaft 22 extending from the support column 20, a lifting mechanism 24 (e.g., a hydraulic lift) for lifting the support shaft 22, wheels 26 attached to the base 18, and a handle 28 to facilitate maneuverability of the engine stand 10.

The base 18 may comprise a U-shaped frame and may include a cross beam 30 for supporting the lifting mechanism 24. The base 18 may be maneuverable via wheels 26 and handle 28. The support column 20 extends from the base 18 and may be pivotable (front to rear) about a horizontal pivot rod 32. As the lifting mechanism 24 lifts the support shaft 22, an upper portion of the support column 20 may pivot rearwardly about the horizontal pivot rod 32. In some embodiments, the support column 20 may be vertically shiftable. For example, the support column 20 may vertically shift as the lifting mechanism 24 extends, instead of pivoting. Alternatively, the lifting mechanism 24 may be housed and/or supported on or in the support column 20 so that extension of the lifting mechanism 24 extends the upper portion of the support column 20.

The support shaft 22 connects the adapter assembly 16 to the support column 20 and extends generally horizontally in a forward direction from the support column 20. The support shaft 22 may be rotatably attached to the support column 20, such that the shaft 22 can rotate about a forwardly-extending horizontal axis. The support shaft 22 may also be rotatably coupled to the lifting mechanism 24 via a bearing 34, which permits the support shaft 22 to rotate while being supported by the lifting mechanism 24. The support shaft 22 may include a gear box 36 with a crankshaft 38 supported on a rear side of the support column 20. The gear box 36 may be configured to rotate the support shaft 22 when the crankshaft 38 is actuated.

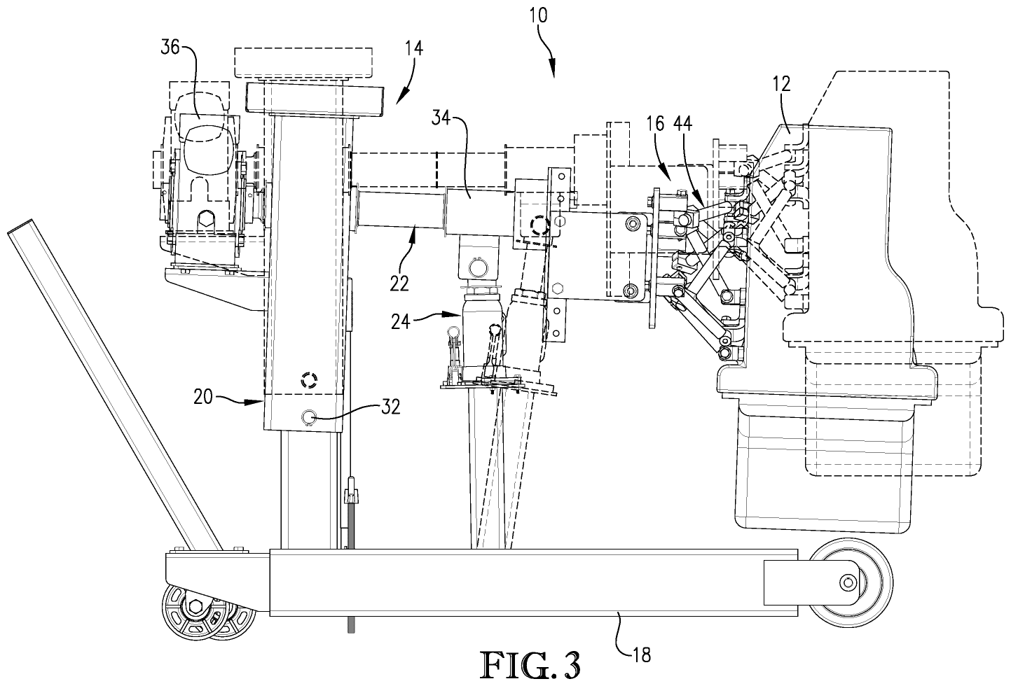

The lifting mechanism 24 raises and lowers the support shaft 22 to provide access to different areas of the equipment 12. The lifting mechanism 24 may be rotatably attached to the cross beam 30 of the base 18 via bearing 40 and extend generally upward to pivot the support shaft 22 about a laterally extending horizontal axis, as depicted in FIG. 3. Additionally or alternatively, the cross beam 30 may be rotatable relative to the rest of the base 18. The lifting mechanism 24 may be hydraulically, pneumatically, mechanically, and/or electrically actuated.

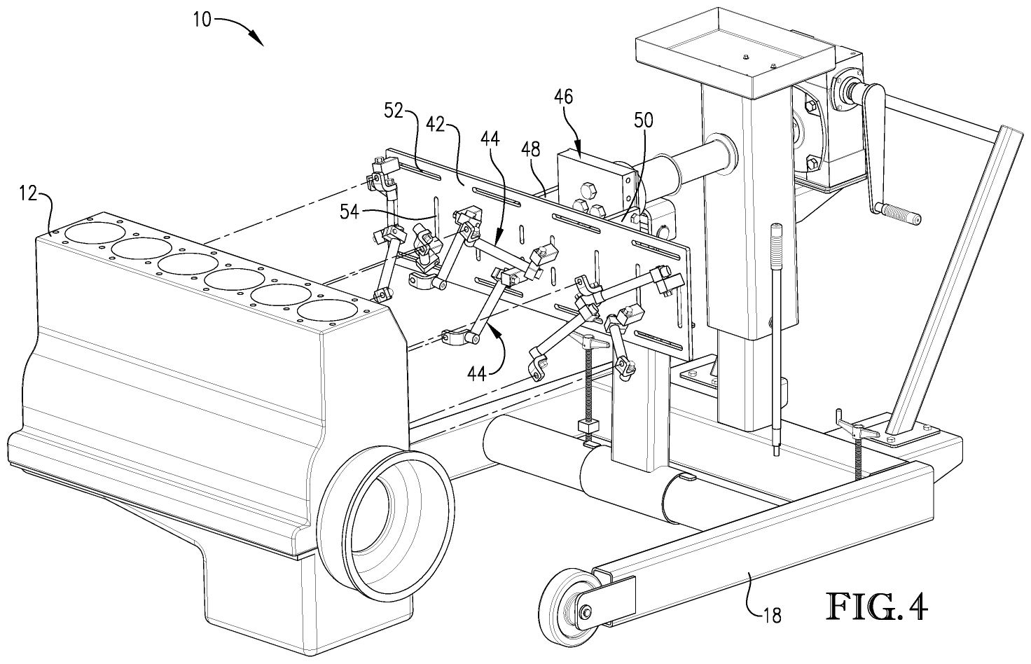

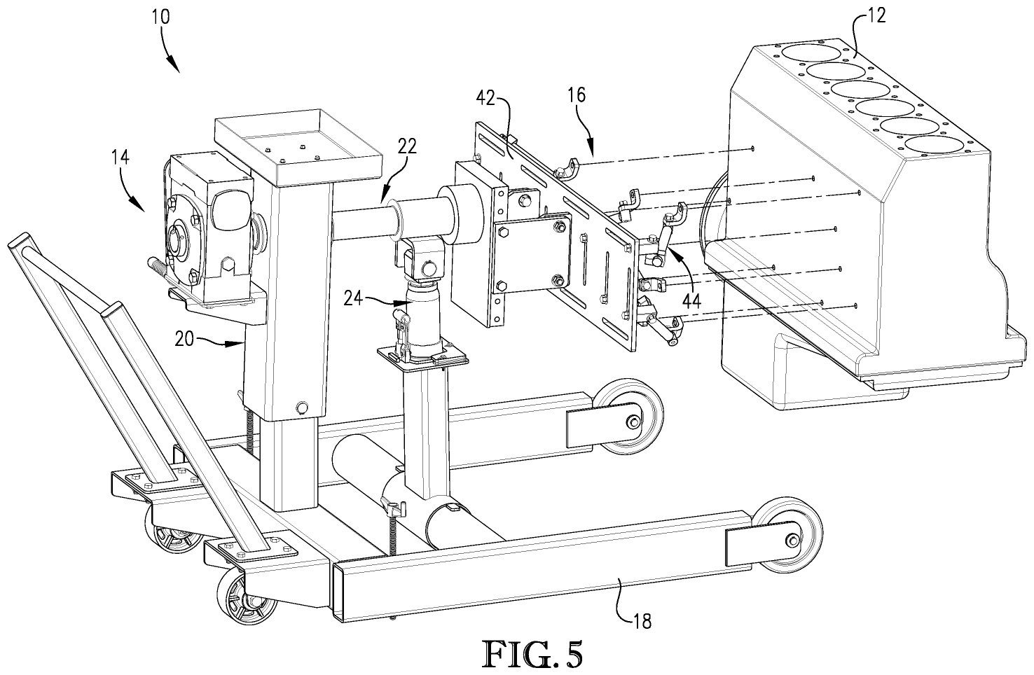

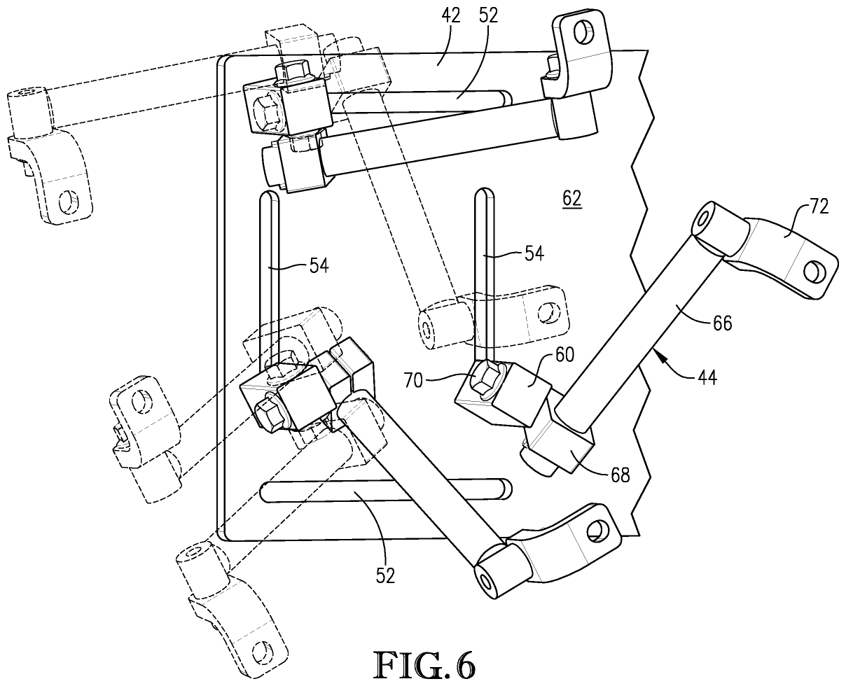

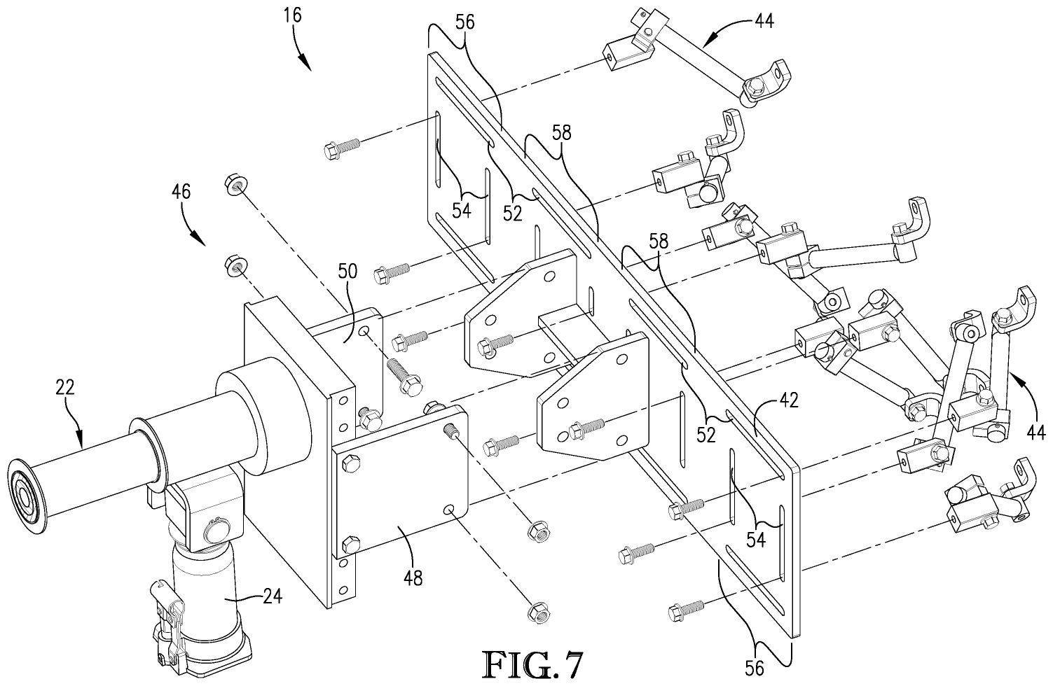

Turning to FIGS. 4-8, the adapter assembly 16 may comprise an adapter plate 42 that includes a plurality of adjustable support arm assemblies 44. The adapter plate 42 may be rigidly secured to the column 20 via a mounting plate bracket 46 comprising a pair of spaced apart mounting plates 48, 50 attached to the support shaft 22. The mounting plates 48, 50 may be bolted to the support shaft 22. As such, the vertical position of the adapter plate 42 can be adjusted via the lifting mechanism 24 of the support frame 14. The adapter plate 42 may comprise a plate-like structure of high-strength material, such as steel. The adapter plate 42 may be formed from a 0.25 inch (6 millimeter (mm)) steel plate, a 0.5 inch (12.7 mm) steel plate, a 0.75 inch (19.05 mm) steel plate, or a 1.0 inch (25.4 mm) steel plate. In some embodiments, the adapter plate 42 may include a plurality of horizontally-extending grooves 52 and a plurality of vertically-extending grooves 54 formed through the thickness of the adapter plate 42. In some embodiments, the adapter plate 42 includes at least eight horizontally-extending grooves 52 and at least eight vertically-extending grooves 54. The adapter plate 42 may comprise a pair of outer sections 56 and a pair of inner sections 58 (as depicted in FIG. 7). The inner sections 58 may be positioned between the outer sections 56. Each of the outer sections 56 and the inner sections 58 may include at least a pair of horizontally-extending grooves 52 and a pair of vertically-extending grooves 54. Embodiments provide for the support arm assemblies 44 to be received within the grooves 48, 50 formed in the adapter plate 42. As described in more detail below, the support arm assemblies 44 are configured to be arranged in various different configurations, such that the engine stand 10 of the present invention can be configured to support various types and sizes of equipment, engines, etc. In some embodiments, the adapter plate 42 may be rectangular and have a length of between 20 and 80 inches (50 and 204 centimeters (cm)), between 30 and 60 inches (76 and 153 cm), or about 44 inches (112 cm). The adapter plate 42 may have a height of between 5 and 25 inches (12 and 64 cm), between 10 and 20 inches (25 and 51 cm), or about 12.5 inches (32 cm).

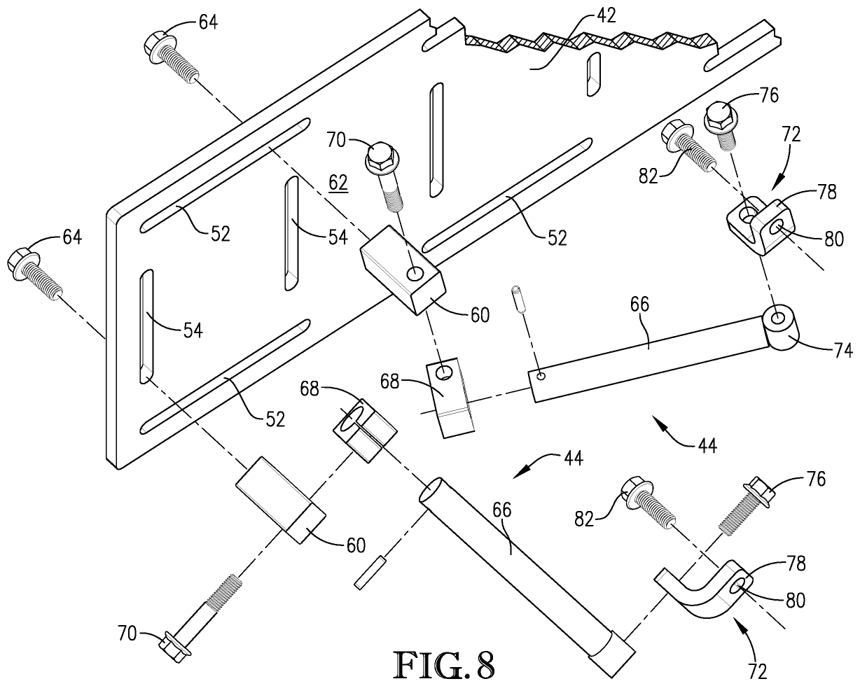

The support arm assemblies 44 are configured to secure the equipment 12 to the adapter plate 42. Each support arm assembly 44 may be positioned in (or otherwise associated with) one of the horizontal or vertical grooves 52, 54, in a manner that permits the support arm assembly 44 to actuate (e.g., slide) within the groove 52, 54. In more detail, as illustrated in FIG. 8, each support arm assembly 44 may include a retainer block 60 that is positioned on an exterior side 62 of the adapter plate 42. The retainer block 60 may be formed as a rectangular block of high-strength material, such as steel. A fastener 64, such as a bolt, may extend through the associated groove 52, 54, so as to secure the retainer block 60 to the adapter plate 42. By loosening the fastener 64, the retainer block 60 (and, thus, the support arm assembly 44) is free to slide upward and downward (for a vertical groove 54) or leftward and rightward (for a horizontal groove 52).

Additionally, the support arm assemblies 44 may be configured to have at least 5 degrees of freedom. For example, with the fastener 64 loosened, the retainer block 60 is free to rotate 360 degrees with respect to the adapter plate 42. As noted previously, with the fastener 64 loosened, the retainer block 60 can be translated up/down or left/right via the grooves 52, 54. Upon the retainer block 60 being actuated to the appropriate position with respect to the groove 52, 54, the fastener 64 can be tightened to secure the retainer block 60 in place on the adapter plate 42. Each support arm assembly 44 may additionally include an elongated sliding rod 66 that is configured to extend and retract with respect to the retainer block 60. The sliding rod 66 may be formed as a cylindrical rod of high-strength material, such as steel. As shown in FIG. 8, a bracket clamp 68 may extend from the retainer block 60, via a bolt 70, to receive the sliding rod 66. The bolt 70 may be tightened to securely hold the sliding rod 66 and loosened to permit the sliding rod 66 to extend and retract with respect to the retainer block 60. Loosening of the bolt 70 may also permit the sliding rod 66 and the bracket clamp 68 to rotate 360 degrees with respect to the retainer block 60 (i.e., rotate about the bolt 70 that secures the sliding rod 66 to the retainer block 60).

Each support arm assembly 44 may further include an arm bracket 72 secured to a distal end 74 (the end opposite the bracket clamp 68) of the sliding rod 66 via a bolt 76. When the bolt 76 is loosened, the arm bracket 72 may be rotated 360 degrees with respect to the distal end 74 of the sliding rod 66 (around the bolt 76). The arm bracket 72 may be formed as an L-shaped bracket of high-strength material, such as steel. A distal end 78 of the arm bracket 72 (the end extending away from the sliding rod 66) may include a through-hole 80 for receiving a bolt 82, which may be used to secure the arm bracket 72 to a fastening location on an engine 12 (or other piece of equipment) that is to be supported by the engine stand 10. One of more of the bolts 64, 70, 76, 82 may be grade 8 bolts.

The adapter plate 42 of embodiments of the present invention, as described above, can be set up in various configurations so as to support various types and sizes of engines 12 (or other pieces of equipment). For example, the adapter plate 42 may be formed with four sections 56, 58, including the pair of outer sections 56 and the pair of inner sections 58. Each of the sections 56, 58 may include at least a pair of horizontal grooves 52 and at least a pair of vertical grooves 54. In some embodiments, the vertical grooves 54 will be positioned between the horizontal grooves 52. Furthermore, in some embodiments, the adapter plate 42 may include a support arm assembly 44 for each groove 52, 54 (i.e., each horizontally-extending groove 52 and/or each vertically-extending groove 54).

However, in some embodiments, the number of support arm assemblies 44 used may be dependent on the size of the engine 12 (or other piece of equipment) that is to be supported by the engine stand 10. For instance, in some embodiments, an engine 12 with a weight under 2,000 lbs may only require a minimum of five support arm assemblies 44. An engine 12 with a weight between 2,000 and 4,000 lbs may require at least eight support arm assemblies 44. An engine 12 weighing over 4,000 lbs may require at least thirteen support arm assemblies 44.

As noted above, embodiments provide for the adapter plate 42 to be configured in multiple configurations or arrangements so as to support various types and sizes of engines 12 (or other pieces of equipment). In some embodiments, each of the support arm assemblies 44 may be configured with at least 5 degrees of freedom. For instance, the position of each of the support arm assemblies 44 may be adjusted vertically or laterally by sliding the retainer blocks 60 vertically or laterally within their respective groove 52, 54. In addition, the retainer blocks 60 may be rotated with respect to the adapter plate 42. In addition, the sliding rods 66 of each support arm assembly 44 may be rotated and/or extended/retracted with respect to its retainer block 60. Furthermore, each arm bracket 72 can be rotated with respect to its sliding rod 66.

To secure an engine to the engine stand, the necessary number of support arm assemblies 44 required to support the engine size 12 (as discussed above) may be secured to the adapter plate 42. Using a shop crane or other suitable mechanism, the engine 12 may be moved into position for attaching to the adapter plate 42. Specifically, with reference to FIG. 4, the engine's 12 center of gravity may be aligned with respect to the engine stand's 10 horizontal axis of rotation (i.e., the axis along the support shaft 22) by raising or lowering the engine 12. If the adapter plate 42 needs to move up or down, the lifting mechanism 24 of the engine stand 10 can be used. Next, the support arm assemblies 44 may be positioned in the most advantageous position so as to be secured to the fastening locations on the engine 12 (e.g., available brackets or threaded through holes or blind holes on the engine 12). Such fastening locations may typically be a combination of lower and higher locations on the engine 12. As noted above, each of the support arm assemblies 44 may be free to actuate about at least 5 degrees of freedom. Bolts 82 may then be extended through the arm brackets 72 of the support arm assemblies 44 and into the engine 12 (or into a bracket associated with the engine 12). Such bolts 82 may be tightened to secure the engine 12 in place. To remove the engine 12 from the adapter plate 42, the above steps may be completed in reverse order.

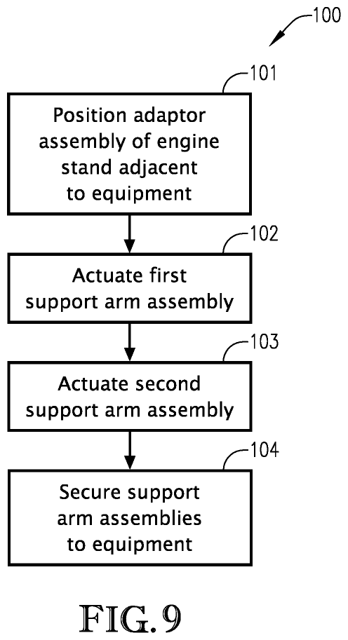

The flow chart of FIG. 9 depicts the steps of an exemplary method 100 of supporting a piece of equipment 12 with an engine stand 10. In some alternative implementations, the functions noted in the various blocks may occur out of the order depicted in FIG. 9. For example, two blocks shown in succession in FIG. 9 may in fact be executed substantially concurrently, or the blocks may sometimes be executed in the reverse order depending upon the functionality involved. In addition, some steps may be optional.

Referring to step 101, an adapter assembly 16 of the engine stand 10 may be positioned adjacent to the equipment 12. The adapter assembly 16 may include an adapter plate 42 having a plurality of horizontally-extending grooves 52 and a plurality of vertically-extending grooves 54. The adapter assembly 16 may additionally include a plurality of support arm assemblies 44 extending from the adapter plate 42. This step 101 may include positioning and/or aligning the engine stand 10 near the equipment 12 via wheels 26 and a handle 28 of the engine stand 10 and raising or lowering the adapter plate 42 via a lifting mechanism 24.

Referring to step 102, a first support arm assembly 44 may be actuated horizontally through a first horizontally-extending groove 52 of the adapter plate 42. For example, a fastener 64 may extend through the groove 54 and engage a retainer block 60 of the first support arm assembly 44 to secure the retainer block 60 at a location along the groove 54. This enables the first support arm assembly 44 to be positioned so that the fastening location of the equipment 12 is within reach of the first support arm assembly 44. This step 102 may also include actuating the first support arm assembly 44 into position near the fastening location on the equipment 12. For example, the retainer block 60 may be rotated about an axis coaxial with the fastener 64. A proximal end of a sliding rod 66 may be secured to the retainer block 60 via a bracket clamp 68. The sliding rod 66 of the first support arm assembly 44 may be extended or retracted relative to the retainer block 60. The sliding rod 66 may also be rotated to orient an arm bracket 72 attached to a distal end of the sliding rod 66 to connect to the fastening location. The arm bracket 72 may also be rotated about an axis perpendicular to the sliding rod 66.

Referring to step 103, a second support arm assembly 44 may be actuated vertically through a first vertically-extending groove 54 of the adapter plate 42. For example, a fastener 64 may extend through the groove 54 and engage a retainer block 60 of the second support arm assembly 44 to secure the retainer block 60 at a location along the groove 54. This enables the second support arm assembly 44 to be positioned so that a second fastening location of the equipment 12 is within reach of the second support arm assembly 44. This step 103 may also include actuating the second support arm assembly 44 into position near the fastening location on the equipment 12. For example, the retainer block 60 may be rotated about an axis coaxial with the fastener 64. A sliding rod 66 of the second support arm assembly 44 may be extended or retracted relative to the retainer block 60. The sliding rod 66 may also be rotated to orient an arm bracket 72 attached to a distal end of the sliding rod 66 to connect to the fastening location. The arm bracket 72 may also be rotated about an axis perpendicular to the sliding rod 66.

Referring to step 104, the first support arm assembly 44 and the second support arm assembly 44 are secured to the equipment 12. This step may include inserting bolts 82 through the arm brackets 72 and fastening the bolts 82 to the equipment 12. This step 104 may also include tightening bolts 64, 70, 76 of the adapter assembly 16 so that the support arm assemblies 44 are in fixed positions, whereby the support arm assemblies 44 are prohibited from moving relative to the adapter plate 42.

The method 100 may include additional, less, or alternate steps and/or device(s), including those discussed elsewhere herein. For example, the method may include rotating a support shaft 22 of the engine stand 10 via a gearbox 36 so that the adapter plate 42 is rotated about an axis coaxial with the support shaft 22. The method 100 may also include attaching additional support arm assemblies 44 to the adapter plate 42.

It is to be understood that while certain forms of the present invention have been illustrated and described herein, it is not to be limited to the specific forms or arrangement of parts described and shown.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claim(s) set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

1. An adapter assembly for an equipment stand, said adapter assembly comprising:
an adapter plate comprising a plurality of horizontally-extending grooves and a plurality of vertically-extending grooves, with each groove being formed through a thickness of said adapter plate; and
a plurality of support arm assemblies extending from said adapter plate and configured to engage with and to support a piece of equipment,
wherein said adapter assembly includes a first support arm assembly associated with a first horizontally-extending groove and a second support arm assembly associated with a first vertically-extending groove.

2. The adapter assembly of claim 1, wherein the adapter plate comprises a pair of outer sections and a pair of inner sections, with the inner sections positioned between the outer sections, wherein each of the outer sections and the inner sections includes at least a pair of horizontally-extending grooves and a pair of vertically-extending grooves.

3. The adapter assembly of claim 1, wherein each support arm assembly includes a retainer block secured to one of the horizontally-extending grooves or the vertically-extending grooves via a fastener.

4. The adapter assembly of claim 3, wherein the fasteners comprise bolts, wherein when the bolts are loosened, the support arm assemblies can be actuated vertically or horizontally via their respective horizontally-extending grooves or vertically-extending grooves.

5. The adapter assembly of claim 4, wherein when the bolts are loosened, the support arm assemblies can be rotated with respect to the adapter plate.

6. The adapter assembly of claim 3, wherein each support arm assembly includes a sliding rod secured to the retainer block, said sliding rod being configured to extend and retract with respect to the retainer block.

7. The adapter assembly of claim 6, wherein each sliding rod is configured to rotate with respect to the retainer block.

8. The adapter assembly of claim 6, wherein each sliding rod is secured to the retainer block via a clamp.

9. The adapter assembly of claim 6, wherein each support arm assembly includes a mounting arm bracket secured to an end of the sliding rod.

10. The adapter assembly of claim 6, wherein the bracket is rotatable with respect to the sliding rod.

11. The adapter assembly of claim 1, wherein each support arm assembly is configured to have at least 5 degrees of freedom

12. An engine stand for supporting an engine above the ground, said engine stand comprising:
a support frame; and
an adapter assembly supported above the ground by the support frame, wherein said adapter assembly includes—
an adapter plate comprising a plurality of horizontally-extending grooves and a plurality of vertically-extending grooves, with each groove being formed through a thickness of said adapter plate,
a plurality of support arm assemblies extending from said adapter plate and configured to engage with and to support the engine above the ground,
wherein said adapter assembly includes a first support arm assembly associated with a first horizontally-extending groove and a second support arm assembly associated with a first vertically-extending groove.

13. The engine stand of claim 12, wherein the support frame is configured to raise and lower the adapter assembly.

14. The engine stand of claim 13, wherein the support frame includes a hydraulic lift for raising and lowering the adapter assembly.

15. The engine stand of claim 12, wherein the support frame includes wheels and a handle for maneuverability of the support frame.

16. The engine stand of claim 12, wherein each support arm assembly is configured to have at least 5 degrees of freedom.

17. The engine stand of claim 12, wherein the adapter plate comprises a pair of outer sections and a pair of inner sections, with the inner sections positioned between the outer sections, wherein each of the outer sections and the inner sections includes at least a pair of horizontally-extending grooves and a pair of vertically-extending grooves.

18. A method of supporting an engine above the ground with an engine stand, said method comprising the steps of:
(a) positioning an adapter assembly of the engine stand adjacent to the engine, wherein the adapter assembly includes an adapter plate having a plurality of horizontally-extending grooves and a plurality of vertically-extending grooves, wherein the adapter assembly additionally includes a plurality of support arm assemblies extending from the adapter plate;
(b) actuating a first support arm assembly horizontally through a first horizontally-extending groove of the adapter plate;
(c) actuating a second support arm assembly vertically through a first vertically-extending groove of the adapter plate; and
(d) securing the first support arm assembly and the second support arm assembly to the engine.

19. The method of claim 18, wherein each support arm assembly includes a retainer block secured to one of the horizontally-extending grooves or the vertically-extending grooves via a fastener, further comprising loosening or tightening the fastener of the first support arm assembly and the fastener of the second support arm assembly.

20. The method of claim 18, further comprising extending or retracting one of the plurality of support arm assemblies with respect to the adapter plate.
